(19) United States
(12) Patent Application Publication
(10) Pub. No.: US 2025/0079956 A1
(43) Pub. Date: Mar. 6, 2025

(54) METHODS TO REDUCE COLD FLAKES IN HIGH PRESSURE DIE CASTINGS

(71) Applicant: GM Global Technology Operations LLC, Detroit, MI (US)

(72) Inventors: Yiwu Xu, Shanghai (CN); Hongyi Zhan, Shanghai (CN); Wenying Yang, Rochester Hills, MI (US); Qigui Wang, Rochester Hills, MI (US)

(21) Appl. No.: 18/467,159

(22) Filed: Sep. 14, 2023

(30) Foreign Application Priority Data
Sep. 1, 2023 (CN) 2023111326916

(51) Int. Cl. H02K 15/14; B22D 17/08; B22D 17/20; B22D 17/28; B22D 17/30; H02K 5/06

(52) U.S. Cl. CPC H02K 15/14; B22D 17/08; B22D 17/2023; B22D 17/28; B22D 17/30; H02K 5/06

(57) ABSTRACT

A die cast part, such as an electric drive unit, a high pressure die casting system, and a method of forming a die cast part. The high pressure die casting system includes a shot sleeve including a pour hole, a launder connected to the pour hole, a furnace connected to the launder, a mold cavity connected to the shot sleeve by a sprue post, and a heating system including at least one proximal channel located under the pour hole under the shot sleeve. The feedstock is melted in the furnace and transferred by a launder into the preheated shot sleeve through a pour hole. The feedstock is injected into a mold cavity, wherein the temperature of the feedstock is above the solidus temperature of the feedstock upon entering the mold cavity.

### BACKGROUND

High pressure die casting is a process for manufacturing near-net shapes or net shapes out of metal, requiring little post process machining. The process is commonly used with aluminum, zinc and magnesium. During the process, molten metal is forced by a plunger from a shot sleeve and into a closed die at relatively high speeds. The molten metal cools and begins to solidify in the die and once sufficiently solid is removed from the die.

However, if the molten metal partially solidifies in the shot sleeve, the solidified layer near the shot sleeve surfaces may result in cold flakes, or particles, which solidify prior to entering the mold cavity. Cold flakes create irregular structures and discontinuities in the finished part. These structures and discontinuities may appear on the surface and interior of the part resulting in surface and internal defects.

While current high pressure die casting processes and systems achieve their intended purpose, room remains for development in the field of high pressure die casting processes and systems to reduce cold flake.

### SUMMARY

Accordingly to various aspects, the present disclosure relates to a high pressure die casting system. The high pressure die casting system includes a shot sleeve including a pour hole, a launder connected to the pour hole, a furnace connected to the launder, a mold cavity connected to the shot sleeve by a sprue post, and a heating system including at least one proximal channel located under the pour hole under the shot sleeve.

In embodiments of the above, the at least one proximal channel extends to the midpoint of the shot sleeve. In further embodiments, the at least one proximal channel includes in the range of two to six parallel channels, parallel to the shot sleeve, and at least one circumferential channel connecting the parallel channels. In further embodiments, the parallel channels are spaced around the lower half of the shot sleeve.

In any of the above embodiments, at least one distal channel is wrapped around at least a portion of the circumference of the shot sleeve by the sprue post. In further embodiments, the at least one distal channel includes two distal channels.

In any of the above embodiments, at least one sprue channel located underneath the sprue post.

In any of the above embodiments, the heating system includes a circulator for hot oil connected to at least one of the at least one proximal channel, the at least one distal channel, and the at least one sprue channel. Alternatively, or additionally, in any of the above embodiments, the heating system includes at least one heating element selected of resistive heating elements and inductive heating elements inserted into at least one of the at least one proximal channel, the at least one distal channel, and the sprue channel.

In any of the above embodiments, an insulation layer is provided over the launder, wherein the amount of insulation and the type of insulation selected provides a melt temperature loss of a feedstock of less than 20 degrees Celsius. In further embodiments, the insulation layer is fiber glass.

According to various additional aspects, the present disclosure is directed to a method of forming a die cast part. The method includes melting a feedstock in a furnace at a furnace temperature, preheating a shot sleeve using a heating system including at least one proximal channel, transferring the feedstock by a launder into a shot sleeve through a pour hole, wherein at least one proximal channel is located under the pour hole under the shot sleeve, and injecting the feedstock into a mold cavity by advancing a plunger in the shot sleeve according to an injection velocity profile, wherein the temperature of the feedstock is above the solidus temperature of the feedstock upon entering the mold cavity.

In embodiments of the above, the method further includes circulating heat transfer fluid through the at least one proximal channel.

In any of the above embodiments, the furnace temperature is 100 degrees Celsius to 150 degrees Celsius above the solidus temperature.

In any of the above embodiments, the solidus temperature is determined by phase simulation.

In any of the above embodiments, the method includes simulating a loss in temperature of the melted feedstock as the melted feedstock is transferred through the launder to determine if the loss in temperature is greater than an allowable temperature loss, and adjusting the amount or type of an insulation surrounding the launder if the temperature is greater than an allowable temperature loss. In further embodiments, the allowable temperature loss is 20 degrees Celsius or less.

In any of the above embodiments, the shot sleeve is preheated at a preheat temperature and the preheat temperature and the injection velocity profile is selected by simulating the temperature of the feedstock in the shot sleeve. In further embodiments, the preheat temperature of the shot sleeve is in the range of 150 degrees Celsius and 200 degrees Celsius and the velocity of the injection velocity profile includes a plurality of velocities in the range of 0.4 meters per second to 0.7 meters per second.

According to several additional aspects, the present disclosure relates to an electric drive unit for a vehicle. The electric drive unit includes a housing having a surface. The housing is formed from a magnesium alloy and exhibits less than ten cold flakes per one square meter at the surface of the housing.

### BRIEF DESCRIPTION OF DRAWINGS

The drawings described herein are for illustration purposes only and are not intended to limit the scope of the present disclosure in any way.

FIG. 1 illustrates a cold flake formation in a die cast part.

FIG. 2 illustrates a die casting system, according to embodiments of the present disclosure.

FIG. 3 illustrates a shot sleeve and die, according to embodiments of the present disclosure.

FIG. 4A illustrates the melt temperature distribution of advancing melt in a shot sleeve without the inclusion of heating channels in the shot sleeve. The scale at the bottom of the figure correlates with the length of the shot sleeve and the scale on the left represents temperature in degrees Celsius.

FIG. 4B illustrates the melt temperature distribution of advancing melt in a shot sleeve without the inclusion of heating channels in the shot sleeve. The scale at the bottom of the figure correlates with the length of the shot sleeve and the scale on the left represents temperature in degrees Celsius.

FIG. 5A illustrates the melt temperature distribution of advancing melt in a shot sleeve with the inclusion of heating channels in the shot sleeve, according to embodiments of the present disclosure. The scale at the bottom of the figure correlates with the length of the shot sleeve and the scale on the left represents temperature in degrees Celsius.

FIG. 5B illustrates the melt temperature distribution of advancing melt in a shot sleeve with the inclusion of heating channels in the shot sleeve, according to embodiments of the present disclosure. The scale at the bottom of the figure correlates with the length of the shot sleeve and the scale on the left represents temperature in degrees Celsius.

FIG. 6 illustrates the connection between the launder and filling tube of a dosing furnace, according to embodiments of the present disclosure.

FIG. 7 illustrates a simulated temperature distribution of melt as the melt is being dropped into an uninsulated shot sleeve. The scale at the bottom of the figure correlates with the size of the melt and the scale on the left represents temperature in degrees Celsius.

FIG. 8 illustrates a simulated temperature distribution of melt as the melt is being dropped into an insulated shot sleeve, according to embodiments of the present disclosure. The scale at the bottom of the figure correlates with the size of the melt and the scale on the left represents temperature in degrees Celsius.

FIG. 9 illustrates a flow chart of a process for selecting melt temperature of feedstock during the die casting process, according to embodiments of the present disclosure.

FIG. 10 illustrates a flow chart of an embodiment of a method for forming a die cast part, according to embodiments of the present disclosure.

FIG. 11 illustrates a vehicle including an electric drive unit housing formed using the system and method described herein.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

In the claims and specification, certain elements are designated as “first,” “second,” “third,” “fourth,” “fifth,” “sixth,” and “seventh.” These are arbitrary designations intended to be consistent only in the section in which they appear, i.e. the specification or the claims or the summary, and are not necessarily consistent between the specification, the claims, and the summary. In that sense they are not intended to limit the elements in any way and a “second” element labeled as such in the claim may or may not refer to a “second” element labeled as such in the specification. Instead, the elements are distinguishable by their disposition, description, connections, and function.

As used herein, the term “vehicle” is not limited to automobiles. While the present technology is described primarily herein in connection with die cast parts used in conjunction with vehicles, the technology is not limited to internal combustion engine vehicles or electric vehicles. The concepts can be used in a wide variety of applications, such as in connection with components used in motorcycles, mopeds, locomotives, aircraft, marine craft, and other vehicles, as well as in other applications incorporating hydrogen fuel cells and in applications incorporating electric motors. Applications include, for example, components industrial machines and motors, agricultural equipment, compressors, defense equipment, HVAC (heating, ventilation, and air conditioning) systems, residential and commercial power generators, and pumps, where lubrication of the component is desirable.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is directed to high pressure die casting systems and methods of forming die cast parts used in a vehicle. High pressure die casting is a process for manufacturing near-net parts or net parts out of metal, requiring little post process machining. Such parts may include, but are not limited to, electric vehicle drive unit cases, gear box covers, housings for sensors including lidar, shade poles, mounting brackets for electric motors and stepper motors, shielding for telematics and other electronic equipment, sensor and airbag housings, fuel intake parts, air-conditioning systems, seatbelt retractor spools, intricate lock barrels, transmission and chassis components, connectors, braking components, and engine blocks.

High pressure die casting may be understood as a process in which molten metal is forced into a sealed mold cavity with a plunger. The metal is held under pressure during solidification to compensate for shrinkage that occurs during the solidification process. In embodiments, the injection pressure, the pressure at which the molten metal is forced into the cavity, is minimal as the shot sleeve is filled in the range of 40 percent to 50 percent. Intensification pressures, the pressure under which the feedstock is held in the cavity during solidification, are in the range of 30 Megapascals (MPa) to 100 MPa, including all values and ranges therein. High pressure die casting is distinguished from, for example, gravity systems, which rely upon gravity to fill out the mold cavity.

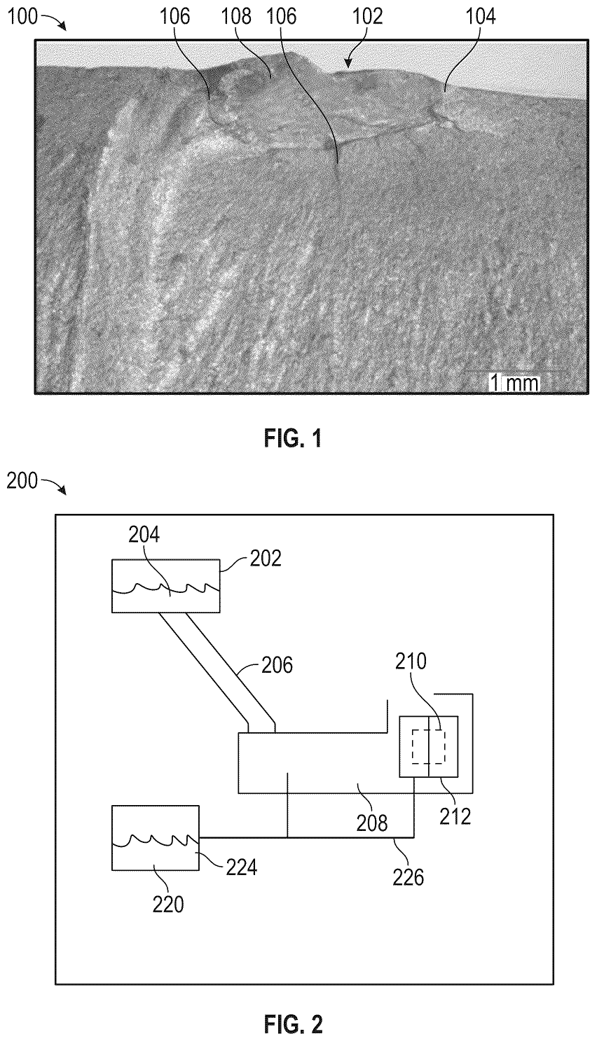

FIG. 1 illustrates a portion of a die cast part 100 including a cold flake 102 present at the surface of the die cast part 100. In the illustrated image, the cold flake 102 results in a disruption in the surface 104 of the die cast part 100. Cracks 106 and other surface deformities 108 can be seen in the surface 104 of the die cast part 100 adjacent to the cold flake 102. In addition to interrupting the surface 104, impacting the surface finish, cold flake 102 may also reduce local material strength. Cold flake 102 may be caused by the solidification and formation of a skin on the melt while the melt is in the shot sleeve of the die cast machine during the dwell time, i.e., the time between the introduction of the melt into the shot sleeve and the time the melt is injected into the mold cavity.

FIG. 2 illustrates an image of a high pressure die casting system 200 for use herein. The high pressure die casting system 200 generally includes a furnace 202 for melting the feedstock 204 for the die casting process. The feedstock 204 includes a metal or metal alloy including one or more of the following metals: magnesium, aluminum, zinc, copper, lead, and tin. The feedstock 204 is then delivered through a trough 206 to the die casting machine 208 through a pour hole 209, described further herein. The die casting machine 208 injects the feedstock 204 into a mold cavity 210 within the mold 212 mounted in the die casting machine 208. The mold cavity 210 is a negative of the component shape and the feedstock 204 takes on the form of the mold cavity 210 to form the die cast part.

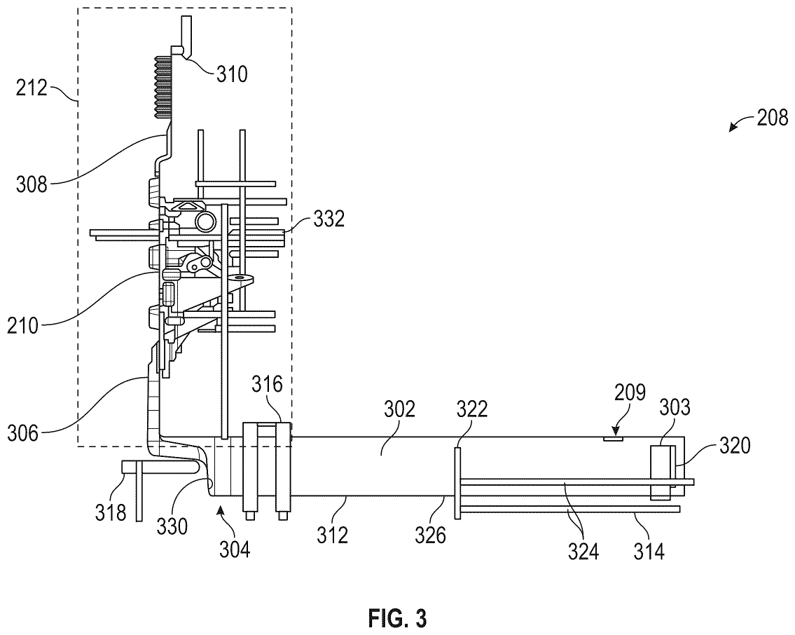

An embodiment of a die casting machine 208 is illustrated in FIG. 3. The die casting machine 208 generally includes a shot sleeve 302 where a “shot” of feedstock 204 is accumulated before the feedstock 204 is injected (or “shot”) into the mold cavity 210 by the advancement of a plunger 303 toward the mold cavity 210. The shot sleeve 302 may be formed from tool steel such as H13. The shot sleeve 302 is connected to a sprue post 304 (also called a “biscuit”), which forms a sprue. The sprue post 304 is connected to the mold cavity 210 through a runner system 306, which may connect the mold cavity 210 at one or more locations to the sprue post 304. The mold 212 may include one or more slides 308, each slide 308 activated by a cam 310.

With reference again to FIG. 2 as well as to FIG. 3, a heating system is provided to prevent temperature losses in the die casting system 200. In embodiments, the heating system includes a circulator 220 that heats and circulates a heat transfer fluid 224, such as oil, through one or more proximal channels 314 surrounding the shot sleeve 302, one or more distal channels 316 surrounding the shot sleeve near the biscuit 304, and one or more channels 318 underneath the sprue biscuit 304, as well as any additional channels, such as channels 332 in the mold, that may be provided. The circulator 220 and the channels 314, 316 may be connected using, for example, insulated hoses 226. The mold 212 also includes one or more channels 332 in the mold cavity. The heat transfer fluid 224 is heated, in the circulator 220, to temperatures of up to 350 degrees Celsius, including all values and ranges such as in the range of 150 degrees Celsius to 200 degrees Celsius, which also circulates the heat transfer fluid 224 through the channels 314, 316, 318. In alternative or additional embodiments, the heating system includes a heating controller (not illustrated) including a power supply and circuitry for processing temperature control algorithms, coupled to a number of resistance heating elements or induction heating elements positioned in the channels 314, 316, 318.

In the illustrated embodiment, the proximal channels 314 extend from underneath the pour hole 209 at a first end 320 of the shot sleeve 302 up to the midway point 322 or proximal to the midway point 332 of the shot sleeve 302. It may be appreciated that in alternative, or additional embodiments, the proximal channels 314 may extend up to the biscuit 304. In embodiments, the proximal channels 314 include parallel channels 324 that are substantially parallel to the shot sleeve 302 as well as a channel 326 that wraps around the shot sleeve 302 proximal to or at the midpoint 322, connecting the parallel channels 324. Further, the parallel channels 324 may be space around the lower half of the shot sleeve 302 below the pour hole 209. For example, in embodiments, between two and six parallel channels 324 may be spaced around the lower half of the shot sleeve 302.

The distal channels 316 are illustrated as wrapping around the entire circumference of the shot sleeve 302 proximal to the biscuit 304 at the second end 330 of the shot sleeve 302. Two distal channels 316 are illustrated, however more than two channels may be present, such as up to ten channels, or, alternatively, only a single channel may be present. In addition, the distal channels 316 may wrap around only a portion of the circumference of the shot sleeve 302. In addition, a sprue channel 318 is provided underneath the sprue post 304. The channels 314, 316, 318 all form circuits, each including an inlet and outlet connected to the circulator 220 for the heat transfer fluid 224 to flow through the channels 314, 316, 318 and prevent stagnation of the heat transfer fluid 224.

The proximal channels 314, distal channels 316, and sprue channels 318 are placed a distance in the range of 50 millimeters (mm) to 2500 mm, including all values and ranges therein from the interior wall 312 of the shot sleeve 302, which the molten feedstock 204 contacts. Further, the channels 314, 316, 318 may assume any number of cross-sections, such as circular, elliptical, rectangular, or square. In addition, the channels 314, 316, 318 may be machined into a block that the shot sleeve 302 is formed in or otherwise contact the shot sleeve 302.

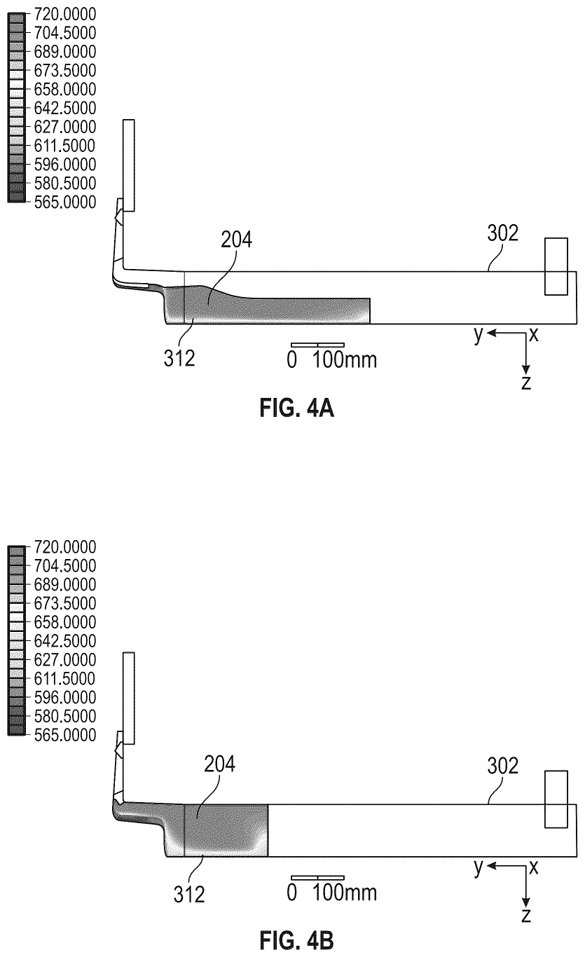

FIGS. 4A and 4B illustrate the loss in melt temperature of the feedstock 204 that does not include the heating system and heating channels 314, 316, 318, as determined using casting process simulation software, such as MagmaSoft, ProCAST, Flow3D, Anycasting, simulation software. The melt temperature, upon introduction to the shot sleeve 302, was determined to be 720 degrees Celsius. After 1.6 seconds of residence time in the shot sleeve 302, 13 percent of the mold cavity 210 was filled, and 0.27 percent of the total weight of the feedstock 204 was found to be solidified. In addition, the feedstock 204 temperature decreased by 100 degrees Celsius approaching the internal wall 312 of the shot sleeve 100 degrees Celsius. Temperature losses increased to 130 degrees Celsius, and 1 percent of the molten feedstock 204 solidified as the feedstock 204 was advanced 200 millimeters through the shot sleeve 302 after 2.4 seconds of residence time, and 27 percent of the mold cavity 210 was filled.

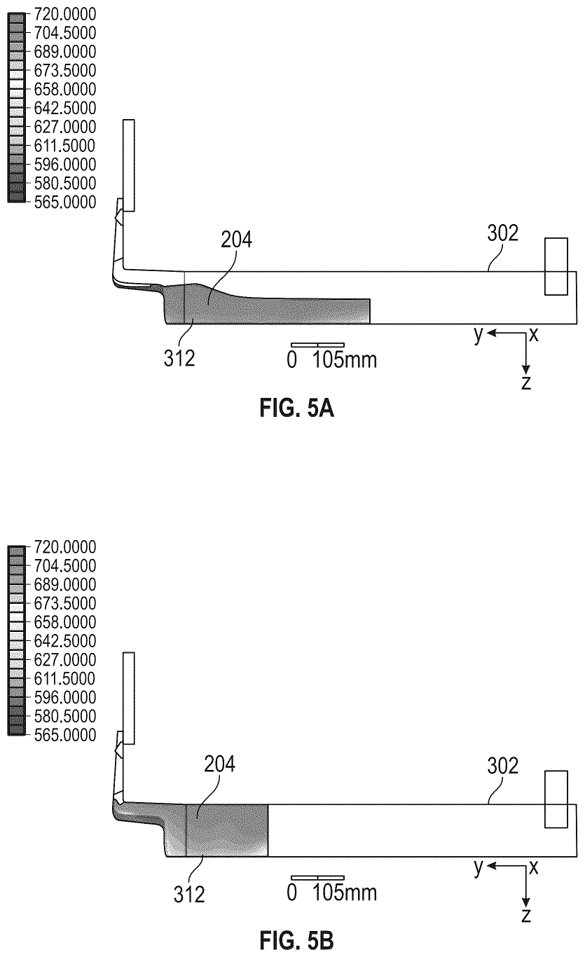

FIGS. 5A and 5B illustrate the loss in melt temperature of the feedstock 204 in a system incorporating heating channels 314, 316, 318 in the shot sleeve 302, as determined using casting process simulation software, such as MagmaSoft, ProCAST, Flow3D, Anycasting, simulation software. The melt temperature upon introduction to the shot sleeve was determined to be 720 degrees Celsius. After 1.6 seconds of residence time in the shot sleeve 302, 13 percent of the mold cavity 210 was filled, zero (0) percent of the total amount of the feedstock 204 was found to be solidified. In addition, the feed stock temperature decreased by 50 degrees Celsius approaching the internal wall 312 of the shot sleeve 100 degrees Celsius. Temperature losses increased to 90 degrees Celsius and 0.03 percent of the feedstock 204 solidified as the molten feedstock 204 was advanced 200 millimeters through the shot sleeve 302 after 2.4 seconds and 28 percent of the mold cavity 210 was filled.

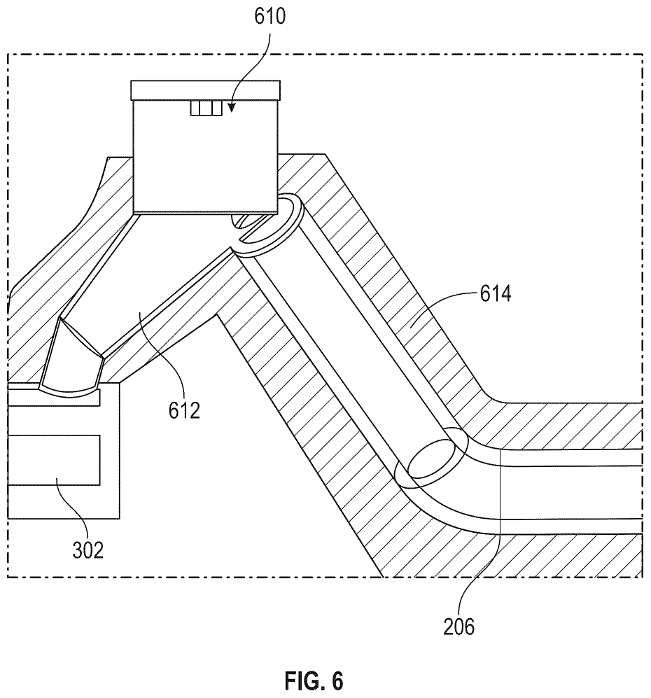

FIG. 6 illustrates a connection between the shot sleeve 302 and the trough 206. In the illustrated embodiment, the trough 206 connects to the shot sleeve 302 through a launder 610; however, it should be appreciated that the filling funnel shown above the launder 610 may be eliminated. In embodiments, to reduce temperature loss in the feedstock 204 upon addition of the feedstock 204, the launder 610 is covered with a layer of insulation 614. The insulation 614 includes, for example, fiberglass, mineral wool, MANNIGLAS® (available from Lydall, Rochester, NH), KAOWOOL Blanket (available from THERMAL CERAMICS INC. Augusta, Georgia), or ceramic. In additional embodiments, the insulation 614 is applied the length of the trough 206 back to the furnace 202. The insulation 614 may exhibit an R value in the range of 2 per inch to 8 per inch, including all values and ranges therein. Further, the insulation is applied at a thickness in the range of 0.5 inch to 6 inches, including all values and ranges therein.

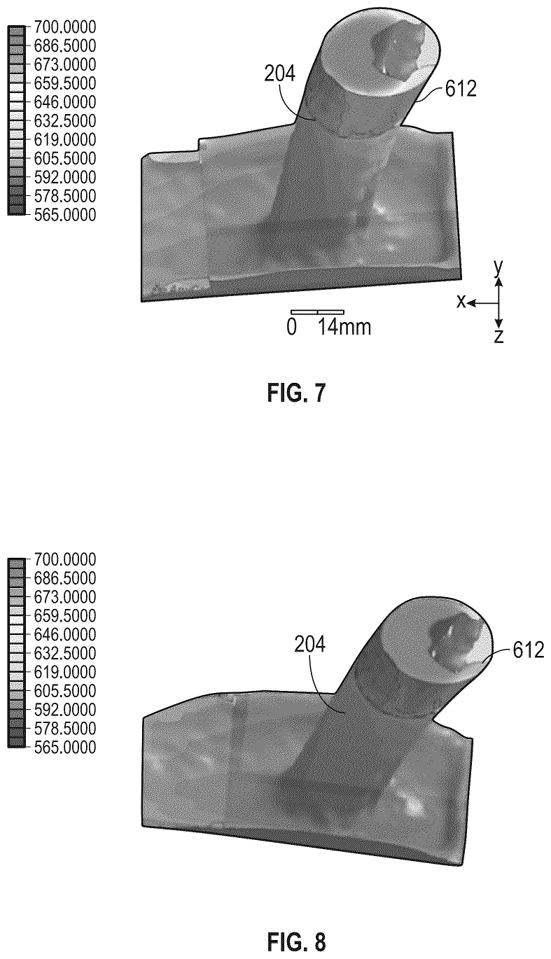

The provision of insulation reduces a loss in melt temperature as the feedstock 204 passes through the launder 610. FIG. 7 illustrates a simulation of the temperature of the feedstock 204 without the use of insulation 0.4 seconds after introducing the feedstock 204 into the shot sleeve 302 from the trough 206. At this point, the shot sleeve 302 is 14 percent full, and 0.03 percent by weight of the feedstock 204 has solidified. In addition, the melt temperature dropped 50 degrees Celsius at the internal wall 612 of the launder 610.

FIG. 8 illustrates a simulation of the temperature of the feedstock 204 with the application of insulation 0.4 seconds after introducing the feedstock 204 into the shot sleeve 302 from the trough 206. At this point, the shot sleeve 302 is 14 percent full, and 0.03 percent by weight of the feedstock 204 has solidified. In addition, the melt temperature dropped only 20 degrees Celsius at the internal wall of the 312 of the launder 610.

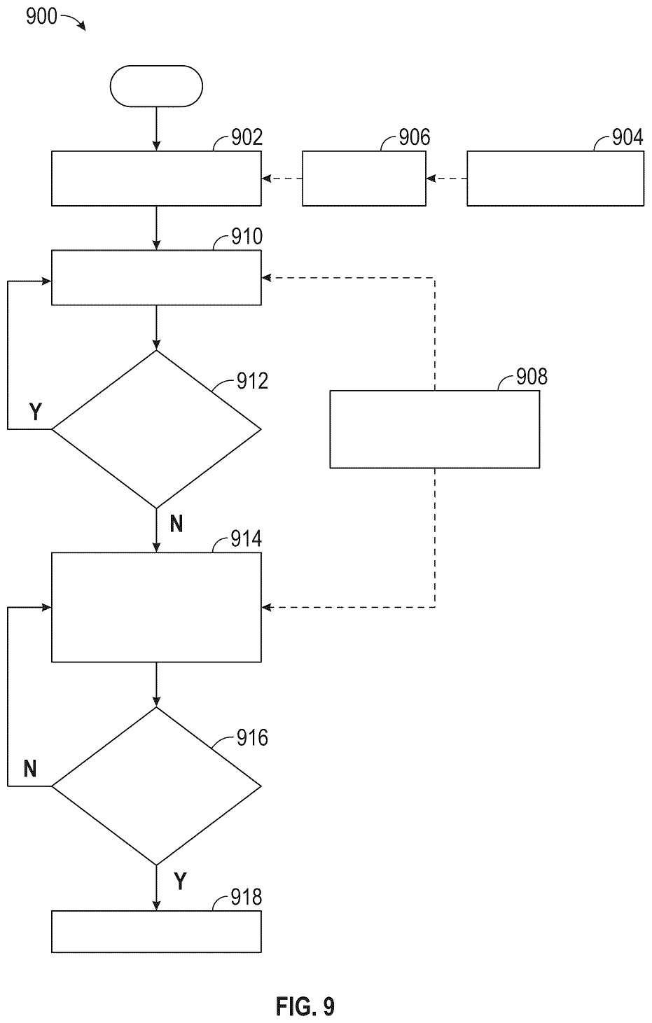

FIG. 9 illustrates a method 900 of simulating the formation of a die cast part according to various embodiments to select process parameters and form the die cast part. Reference is also made herein to FIGS. 2, 3 and 6. At block 902 an assumption is made as to the temperature the feedstock 204 is upon exiting the furnace 202. In embodiments, the temperature for melting the feedstock 204 in the furnace, i.e., furnace temperature, is selected at block 906 using phase simulations performed at block 904. The phase simulations at block 904 determine a solidus temperature of the feedstock 204, particularly where the feedstock may be a multi-component alloy. The simulation software for performing such simulations may include, for example, CALPHAD code such as Thermo-Calc, Pandat, JMatPro, etc. The solidus temperature may be understood as the highest temperature at which an alloy is solid. In addition, the amount of feedstock 204 needed to fill the cavity in a shot is determined based upon the volume of the cavity. It is noted that the shot sleeve 302 may be filled only 40 percent to 50 percent. Then at block 906, the furnace temperature is specified based on a calculations of the expected amount of loss in temperature as the feedstock 204 is transferred from the furnace 202 to the launder 610 and then injected from the shot sleeve 302. However, the furnace temperature selected may not exceed a temperature that might degrade the material or constituents of the material, or cause issues in processing, such as undesirable phase transformations in the feedstock 204.

At block 908, thermal analysis and simulations of the die casting process are performed using the temperature of the feedstock 204 as the feedstock 204 exits the furnace 202 as a constraint. At block 910 a simulation is performed of the melted feedstock 204 passing through the launder 610, insulated as described above, and into the pour hole 209 of the shot sleeve 302. At block 912 a determination is made as to whether the melt temperature loss of the feedstock 204 passing through the launder 610 in the simulation is greater than or less than the allowable melt temperature loss, T_{allowable}. This is determined based on whether the melt temperature drops below the solidus temperature passing through the launder 610, or in the shot sleeve 302, and may be in the range, for example, of up to 20 degrees Celsius, including all values and ranges therein, to prevent any temperature losses seen during injection that reduces the melt temperature to a temperature below the solidus temperature. The casting process simulation may be run using simulation software such as MagmaSoft, ProCAST, Flow3D, Anycasting.

If the temperature loss is greater than the allowable melt temperature loss, T_{allowable}, at block 912 then the simulation at block 910 is rerun by modifying a parameter, such as the amount or type of insulation 614 for the launder 610 or by beginning with a higher feedstock melt temperature and furnace temperature. If the temperature loss is less (not greater) than the allowable melt temperature loss, T_{allowable}, at block 912 then at block 914 a simulation is performed to optimize localized shot sleeve preheat temperature at the interior wall 312 and the shot injection profile including speeds for advancing the feedstock 204 through the shot sleeve 302 with the plunger 303 using the simulation software noted above. At block 916, a determination is made as to whether the temperature of the feedstock 204 falls below the solidus temperature in the shot sleeve 302 or if the temperature of the feedstock 204 in the shot sleeve 302 is too high, such that the feedstock 204 will not properly solidify in the mold cavity 210 as it may take too long to solidify or may exhibit an undesirable phase upon solidification due to the cooling profile.

If the temperature of the feedstock 204 falls below the solidus temperature in the shot sleeve 302, then the injection profiles are adjusted, and the simulation run at block 914 is repeated. Various aspects of the process may be adjusted to modify the feedstock temperature 204 in the shot sleeve 302 and during injection. For example, the preheat temperature of the shot sleeve 302 may be adjusted using the heating system. In addition, the velocity profile, i.e., the injection profile, of the plunger 303 in the shot sleeve 302 may be adjusted. As illustrated below, the injection profile affects the temperature of the feedstock 204 in the shot sleeve 302. However, the injection profile speeds are limited; if the profile speeds are too fast then turbulence is introduced into the feedstock 204, which may lead to defects in the die cast part, such as the entrapment of oxides or the inclusion of pores. If the temperature of the feedstock 204 does not fall below the solidus temperature in the shot sleeve 302, then die cast parts may be produced at block 918 using the various parameters determined in the method 900 described above.

During the simulations noted above, various known constraints are entered into the system including, for example, the geometry of the various components of the die casting system 200, the coefficient of thermal expansion of the various materials used in the die casting system 200 and the feedstock 204, and the thermal conductivity coefficient k of the various materials used in the die casting system 200 and the feedstock 204. In addition, various variables are entered into the system, including, for example, the temperature of the feedstock 204 leaving the furnace and entering the launder 610, the temperatures of the feedstock 204 leaving the launder 610 and entering the shot sleeve 302, the weight of the feedstock 204 being transferred through the system 200, and the rate at which the feedstock 204 flows through each part of the system 200.

Table 1 provides a non-binding illustrative example of the effect of the injection profile and oil temperature on melt temperature loss in the feedstock. The base speed may represent the speed used in a standard, or initial, injection profile and the proposed speed 1 and proposed speed 2 are exemplary modifications that made be made to an initial injection profile.

TABLE 1
Injection Profile and Oil Temperature
versus Melt Temperature Loss

| | Base Speed | Proposed Speed | Proposed Speed |
|---|---|---|---|
| Plunger Position | (meters | 1 (meters | 2 (meters |
| (mm) | per second) | per second) | per second) |
| 100 | 0.25 | 0.3 | 0.4 |
| 200 | 0.3 | 0.35 | 0.45 |
| 400 | 0.4 | 0.5 | 0.6 |
| 500 | 0.4 | 0.55 | 0.7 |
| 650 | 0.25 | 0.55 | 0.7 |
| Oil Temperature | | | |
| (degrees Celsius) | Melt Temperature Loss (degrees Celsius) | | |
| 180 | 60 | 58 | 52 |
| 220 | 59 | 56 | 50 |

As can be seen above increasing the flow rate across the injection profile, i.e., at the various plunger positions, may reduce the melt temperature loss of the feedstock 204. This may be due to, for example, a reduction in the residence time of the feedstock 204 in the shot sleeve 302. Residence time may be understood as the time the feedstock 204 remains within the shot sleeve 302.

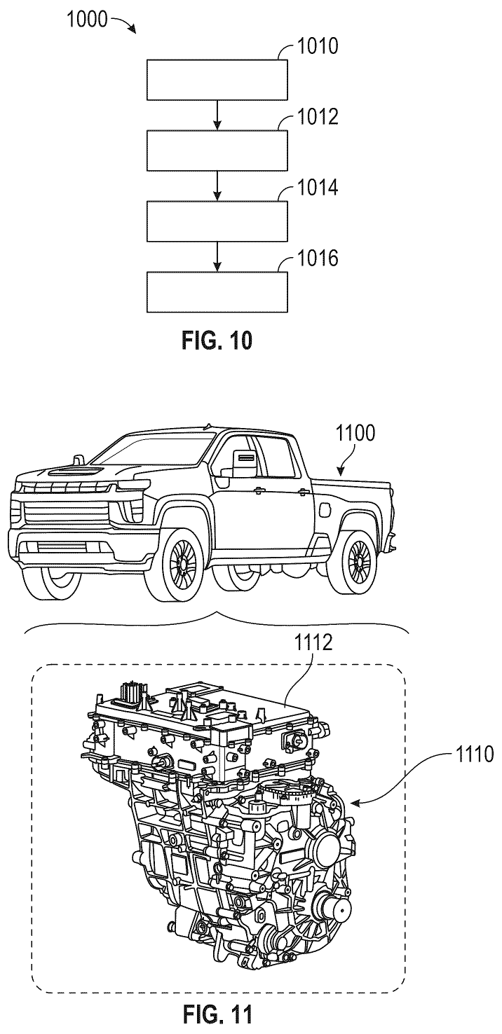

FIG. 10 illustrates a method 1000 of forming a die cast part. Reference is also made herein to FIGS. 2, 3, 6 and 9. At block 1010 the feedstock 204 is melted in the furnace 202 at the furnace temperature, selected at block 906 as described above. In embodiments, the furnace temperature is in the range of 100 degrees Celsius to 150 degrees Celsius above solidus temperature, including all values and ranges therein. At block 1012 the feedstock 204 is transferred through the trough 206 and launder 610 into the shot sleeve 302. The amount or type of insulation 614 surrounding the trough 206 and launder 610 may be adjusted based on the simulations performed at block 910 prior to transferring the feedstock 204 through the trough 206 and launder 610. In embodiments, the amount of insulation and the type of insulation selected provides a melt temperature loss of a feedstock of less than 20 degrees Celsius and selected from the insulation materials noted above. Further, the shot sleeve 302 is preheated to a temperature selected at block 914. In embodiments, the shot sleeve 302 is preheated using heat transfer fluid heated to a preheat temperature in the range of 150 degrees Celsius and 200 degrees Celsius. In embodiments, the temperature loss in the shot sleeve 302 is no greater than 50 degrees Celsius. Vacuum is applied to the shot sleeve 302 to prevent reactive gases, including water vapor, from entering the shot sleeve 302. At block 1014, the feedstock 204 is injected into the mold cavity 210. In embodiments, the velocity of the injection profile is in the range of 0.4 meters per second to 0.7 meters per second. Further, the temperature loss of the feedstock during injection is, in embodiments, no greater than 100 degrees Celsius. During the injection stage, the injection profile is selected based upon the simulations run at block 914. At block 1016, the feedstock 204 is held under pressure in the mold cavity 210. The pressure is provided through advancement of the plunger 303 to continue to fill the mold cavity 210 with feedstock 204 as the feedstock 204 shrinks while cooling in the mold cavity 210. Once sufficiently solidified, the die cast part is removed from the mold cavity 210, such as by manual removal or removal using ejector system in the mold 212 and triggered by the opening of the mold 212 to expose the mold cavity 210.

In embodiments, the die cast part is a drive unit housing for an electric motor used in a vehicle. Reference is made to, for example, FIG. 11 illustrating a vehicle 1100 including an electric drive unit 1110 including a housing 1112 formed from, for example, a magnesium alloy AE44 (Mg-4% Al-4% Re) using the methods and systems described above. The electric drive unit housing may exhibit less than 10 cold flakes per one square meter of the surface of the housing. Alternatively, or additionally as more than one die cast may be formed during a single cycle, the die cast part is a drive unit cases, drive unit supporter, gear box cover, housing for sensors including lidar, a shade pole, mounting bracket for electric motors and stepper motors, shielding for telematics and other electronic equipment, sensor and airbag housing, fuel intake part, air-conditioning system, seatbelt retractor spool, intricate lock barrel, transmission and chassis component, connector, braking component, and engine blocks.

The systems and methods of reducing cold flakes in high pressure die casting herein offer a number of advantages. These advantages include, for example, improving the mechanical properties of the metal castings. These advantages also include, for example, improving surface characteristics. These advantages further include, for example, reducing cold flake structural irregularities in cast parts. These advantages yet further include, for example, reduced scrap rate.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A high pressure die casting system, comprising:
a shot sleeve including a pour hole;
a launder connected to the pour hole;
a furnace connected to the launder;
a mold cavity connected to the shot sleeve by a sprue post; and
a heating system including at least one proximal channel located under the pour hole under the shot sleeve.

2. The high pressure die casting system of claim 1, wherein the at least one proximal channel extends to the midpoint of the shot sleeve.

3. The high pressure die casting system of claim 2, wherein the at least one proximal channel includes in the range of two to six parallel channels, parallel to the shot sleeve, and at least one circumferential channel connecting the parallel channels.

4. The high pressure die casting system of claim 3, wherein the parallel channels are spaced around the lower half of the shot sleeve.

5. The high pressure die casting system of claim 3, further comprising at least one distal channel wrapped around at least a portion of the circumference of the shot sleeve by the sprue post.

6. The high pressure die casting system of claim 5, wherein the at least one distal channel includes two distal channels.

7. The high pressure die casting system of claim 5, further comprising at least one sprue channel located underneath the sprue post.

8. The high pressure die casting system of claim 7, wherein the heating system further comprises a circulator for hot oil connected to the at least one proximal channel, the at least one distal channel, and the at least one sprue channel.

9. The high pressure die casting system of claim 7, wherein the heating system further comprises at least one heating element selected of resistive heating elements and inductive heating elements inserted into the at least one proximal channel, the at least one distal channel, and the sprue channel.

10. The high pressure die casting system of claim 1, wherein an insulation layer is provided over the launder, wherein the amount of insulation and the type of insulation selected provides a melt temperature loss of a feedstock of less than 20 degrees Celsius.

11. The high pressure die casting system of claim 10, wherein the insulation layer is fiber glass.

12. A method of forming a die cast part, comprising:
melting a feedstock in a furnace at a furnace temperature;
preheating a shot sleeve using a heating system including at least one proximal channel;
transferring the feedstock by a launder into a shot sleeve through a pour hole, wherein at the least one proximal channel is located under the pour hole under the shot sleeve; and
injecting the feedstock into a mold cavity by advancing a plunger in the shot sleeve according to an injection velocity profile,
wherein the temperature of the feedstock is above the solidus temperature of the feedstock upon entering the mold cavity.

13. The method of claim 12, further comprising circulating heat transfer fluid through the at least one proximal channel.

14. The method of claim 12, wherein the furnace temperature is 100 degrees Celsius to 150 degrees Celsius above the solidus temperature.

15. The method of claim 14, wherein the solidus temperature is determined by phase simulation.

16. The method of claim 15, further comprising simulating a loss in temperature of the melted feedstock as the melted feedstock is transferred through the launder to determine if the loss in temperature is greater than an allowable temperature loss; and adjusting the amount or type of an insulation surrounding the launder if the temperature is greater than an allowable temperature loss.

17. The method of claim 16, wherein the allowable temperature loss is 20 degrees Celsius or less.

18. The method of claim 15, wherein the shot sleeve is preheated at a preheat temperature and the preheat temperature and the injection velocity profile is selected by simulating the temperature of the feedstock in the shot sleeve.

19. The method of claim 18, wherein the preheat temperature of the shot sleeve is in the range of 150 degrees Celsius and 200 degrees Celsius and the velocity of the injection velocity profile includes a plurality of velocities in the range of 0.4 meters per second to 0.7 meters per second.

20. (canceled)

21. The high pressure die casting system of claim 1, wherein the at least one proximal channel extends to the sprue post.
